(19) United States
(12) Patent Application Publication
(10) Pub. No.: US 2025/0144547 A1
(43) Pub. Date: May 8, 2025

(54) CATALYTIC HEATER UNIT FOR HEATING WET CRUDE OIL TO ENHANCE PROCESSING

(71) Applicant: SAUDI ARABIAN OIL COMPANY, Dhahran (SA)

(72) Inventors: Hatim Awad ALSHAMMARI, Ras Tanura (SA); Shahid M. ALHINDI, Ras Tanura (SA); Abdullah S. ALHUSSAIN, Ras Tanura (SA)

(73) Assignee: SAUDI ARABIAN OIL COMPANY, Dhahran (SA)

(21) Appl. No.: 18/503,927

(22) Filed: Nov. 7, 2023

(51) Int. Cl. B01D 17/04; B01D 17/02; B01D 19/00; B01J 23/42; B01J 35/04; C10G 53/02

(52) U.S. Cl. CPC B01D 17/042; B01D 17/0214; B01D 19/0068; B01J 23/42; B01J 35/56; C10G 53/02; C10G 2300/70

(57) ABSTRACT

Methods and systems of using a catalytic heater unit to heat a wet crude oil to enhance processing of the oil. The methods and systems include using the catalytic heater unit to enhance separating a wet crude oil into a gas fraction, an aqueous fraction, and an oil fraction. The wet crude oil may pass through a two-way separator to separate a portion of the gas fraction from the aqueous fraction and the oil fraction prior to heating to a predetermined temperature in a catalytic heater unit. The catalytic heater unit may include a plurality of catalytic heating pads surrounding at least a portion of a plurality of oil stream channels. The heated wet crude oil then passes through a three-way separator to separate the remaining gas fraction, the aqueous fraction, and the oil fraction.

### FIELD OF THE DISCLOSURE

The present disclosure relates generally to systems, processes and devices for heating wet crude oil and, more particularly, to systems, processes, and devices for heating wet crude oil to enhance processing of the oil.

### BACKGROUND OF THE DISCLOSURE

Wet crude is a mixture of gas(es), oil, and water. Before wet crude oil can be refined, it typically undergoes processing to separate the oil fraction from the gas and aqueous fractions. Typically, wet crude oil first passes through a low pressure production trap (LPPT), which is a two-way separator operable to separate most of the gas fraction from the liquid fraction, which includes the crude oil fraction and aqueous fraction. The oil and water mixture discharged from the LPPT is then conveyed to a three-way separator commonly referred to as a “degassing tank”. In the three-way separator, the remaining gas fraction is lifted to a gas stream and the aqueous fraction is separated from the oil fraction and both oil and water streams are drained from the tank.

It has been observed that the processes for separating the gas fraction and aqueous fraction from wet crude oil are inefficient and can result in a significant amount of water and gas being carried over in the crude oil as it exits the three-way separator. For example, three-way separators are typically designed to function optimally for crude oil having specific fluid characteristics. If the fluid characteristics change, such as changes in the water cut percent or gas oil ratio, then the operating efficiency of the three-way separator may be negatively impacted. Systems, processes, and devices are needed to allow for more efficient separation of the gas and aqueous fractions from crude oil prior to refining.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method of separating a wet crude oil into a gas fraction, an aqueous fraction, and an oil fraction, may include passing the wet crude oil through a two-way separator to separate a portion of the gas fraction from the aqueous fraction and the oil fraction. The wet crude oil from the two-way separator is then preheated to a predetermined temperature in a catalytic heater unit. The catalytic heater unit may include a plurality of catalytic heating pads surrounding at least a portion of a plurality of oil stream channels. The heated wet crude oil is then passed through a three-way separator to separate into the remaining gas fraction, the aqueous fraction, and the oil fraction.

According to another embodiment consistent with the present disclosure, a system for separating wet crude oil into a gas fraction, an aqueous fraction, and an oil fraction, may include a two-way separator operable to separate at least a portion of a gas fraction from the wet crude oil, a catalytic heater unit arranged to receive the wet crude oil from the two-way separator and operable to heat the wet crude oil to a predetermined temperature and thereby generate a heated wet crude oil, and a three-way separator arranged to receive the heated wet crude oil from the catalytic heater unit and operable to separate the heated wet crude oil into the gas fraction, the aqueous fraction, and the oil fraction

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic illustration of a prior art wet crude oil processing system.

FIG. 2 is a schematic illustration of a catalytic heating system for a wet crude oil processing system in accordance with embodiments of the disclosure.

FIG. 3 is a schematic illustration of a catalytic heating system for a wet crude oil processing system in accordance with embodiments of the disclosure.

FIG. 4 is a flowchart of a method operating a wet crude oil processing system in accordance with embodiment of the disclosure

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to systems, processes and devices for heating wet crude oil and, more particularly, to systems, processes, and devices for heating to enhance processing of the wet crude oil. Wet crude oil typically includes a gas fraction, an aqueous fraction, and an oil fraction. Prior to processing, the oil fraction needs to be separated from the gas and aqueous fractions. Most gas and oil separation plants (GOSPs) face challenges in separating the oil fraction from the gas and aqueous fractions in wet crude oil, and thereby produce oil with required specification. Enhancing this separation process can be achieved by applying various processes such as, but not limited to, heating the wet crude oil stream, injecting various chemicals into the wet crude oil, and using multiple process steps to achieve the desire product.

The present disclosure describes systems and processes used to help enhance the separation of the oil fraction from the gas and water fractions by using a customized catalytic heater unit upstream from a three-way separator or “degassing tank.” The catalytic heater may comprise a flameless combustion heater that operates when a hydrocarbon-based fuel gas encounters a certain catalyst in the presence of air by undergoing a chemical combustion reaction. The result of the chemical combustion reaction is the release of radiant heat, which can be highly efficient and environmentally friendly. The radiant heat may be directed at the wet crude oil to increase its temperature. The customized catalytic heater may be able to provide sufficient thermal energy and efficient heat transfer to ensure a desired temperature for the wet crude oil prior to feeding the wet crude oil to the degassing tank to enhance the separation of the gas and aqueous fractions from the crude oil fraction.

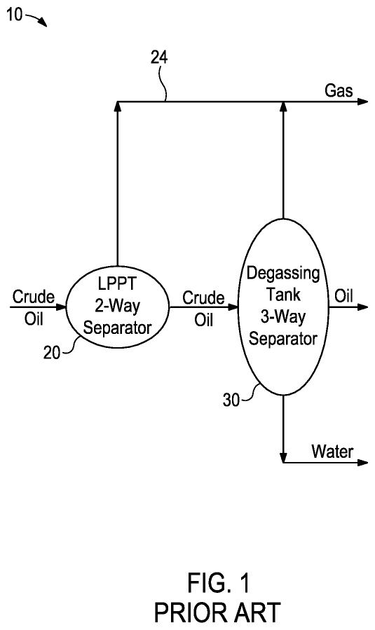

FIG. 1 is a schematic illustration of a prior art wet crude oil processing system 10. Wet crude oil flows into a two-way separator 20, sometimes referred to as a low-pressure production trap (LPPT), where most of the gas fraction included in the wet crude oil is separated from the crude oil. The gas fraction lifted from the crude oil in the two-way separator 20 may be fed into a gas stream 24 and the crude oil exiting the two-way separator 20 flows into a three-way separator 30, sometimes referred to as a “degassing tank”. In the three-way separator 30, the wet crude oil may be separated into a gas fraction, an aqueous fraction (e.g., water), and an oil fraction. The gas fraction may be fed into the gas stream 24 to combine with the gas discharged from the two-way separator 20, the aqueous fraction may be drained for further clean up and processing, and the crude oil fraction may be conveyed downstream for storage or further processing. Embodiments of the disclosure are directed to processes and systems that improve the prior art wet crude oil processing system 10 by heating the wet crude oil prior to introducing the wet crude oil into the three-way separator 30.

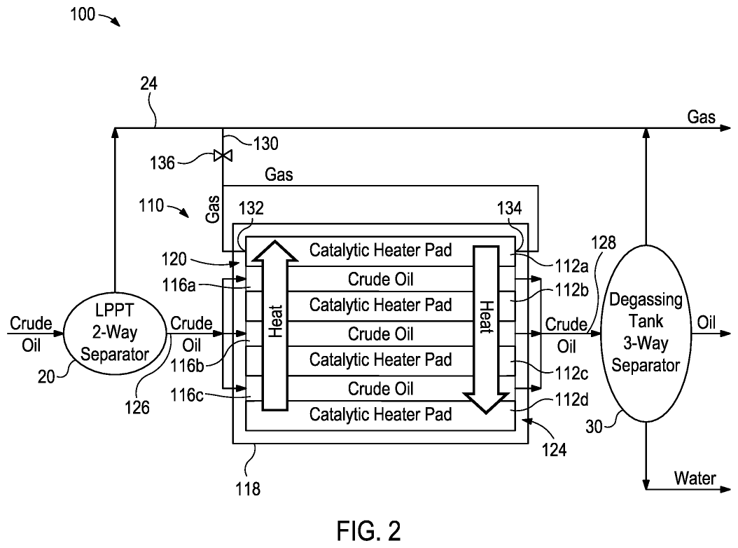

FIG. 2 is a schematic diagram of an example wet crude oil degassing and dewatering system 100 that may incorporate one or more principles of the present disclosure. As illustrated, the system 100 includes a catalytic heater unit 110, which may be included between the two-way separator 20 and the three-way separator 30 to provide sufficient heat to the wet crude oil in order to increase its temperature and enhance the oil water separation in the three-way separator 30.

The catalytic heater unit 110 functions as a heat exchanger for heating the wet crude oil. In embodiments, the catalytic heater unit 110 has or includes a plurality of catalytic heating layers or pads 112a, 112b, 112c, 112d mounted in between and surrounding at least a portion of a plurality of oil stream channels 116a, 116b, 116c. In embodiments, the oil stream channels 116a, 116b, 116c are wrapped in a catalytic heating pads 112a, 112b, 112c, 112d. The catalytic heater unit 110 may include an outer covering 118 enclosing the catalytic heating pads 112a, 112b, 112c, 112d. The outer covering 118 may encompass a plurality of catalytic heating pads 112a, 112b, 112c, 112d and their respective oil stream channels 116a, 116b, 116c. In an embodiment, the outer covering encompasses an individual oil stream channel (i.e., one of oil stream channel 116a, 116b, or 116c) wrapped in a catalytic heating pad (not shown). The outer covering 118 may include openings, such as gas inlets 132, 134 and spacing through which air and gas flow to fuel the catalytic heating reaction.

In embodiments, the catalytic heating pads may include a catalyst capable of catalyzing an exothermic reaction of a hydrocarbon fuel with air. In embodiments, the catalyst is a platinum-based catalyst. The catalyst heating pad may also include a substrate on which the catalyst is coated. In embodiments, the substrate may be fiberglass substrate. In embodiments, the substrate coated with catalyst may be a square mesh that may assist with even distribution of heat from the catalyzed reaction.

In embodiments, an electric voltage may be applied to a spot in a catalytic pad 112a, 112b, 112c, 112d causing it to generate heat until it reaches an activation temperature for the catalytic heater pad. In embodiments, the activation temperature may be at least 200° F. In other embodiments, the activation temperature may be in a range from about 200° F. to about 300° F. In embodiments, the activation temperature is about 250° F. After reaching the activation temperature, a hydrocarbon-based fuel such as natural gas may be introduced to the catalytic heating pad 112a, 112b, 112c, 112d with air to produce an exothermic chemical reaction. The chemical reaction produces heat (thermal) energy that radiates outward from the catalytic heating pads 112a, 112b, 112c, 112d to be absorbed by the oil stream channels 116a, 116b, 116c. Wet crude oil flowing through the oil stream channels 116a, 116b, 116c is thereby heated by the heat radiating from the catalytic heating pads 112a, 112b, 112c, 112d. The heat generated from the catalytic heating pads 112a, 112b, 112c, 112d may circulate throughout the unit 110 to maximize the heat distribution to the wet crude oil and ensure that the required heat duty is delivered. In embodiments, the catalytic heater unit 110 heats the wet crude oil to a predetermined temperature. In embodiments, the predetermined temperature is at least 140° F. In other embodiments, the predetermined temperature is a range from about 142° F. to about 158° F. In an embodiment, the predetermined temperature is about 145° F.

The catalytic heater unit 110 has an inlet end 120 and an outlet end 124 opposite the inlet end 120. Wet crude oil discharged from the two-way separator 20 enters at the inlet end 120 and heated wet crude oil exits at the outlet end 124. In an embodiment, wet crude oil exiting the two-way separator 20 flows to the catalytic heater unit 110 via a wet crude oil stream line 126. In embodiments, the wet crude oil stream line 126 may split into a plurality of fluidly connected lines that form or are otherwise fluidly coupled to the oil stream channels 116a, 116b, 116c of the catalytic heater unit 110. In other embodiments, the wet crude oil stream line 126 flows into a manifold on the catalytic heater unit 110 that splits into the oil stream channels 116a, 116b, 116c of the catalytic heater unit 110.

At the outlet end 124 of the catalytic heater unit 110, the oil stream channels 116a, 116b, 116c may be combined into a single outlet line 128 in a manifold or other similar structure. The outlet line 128 delivers the crude oil to the three-way separator 30.

In the three-way separator 30, the heated wet crude oil is separated into a gas fraction, an oil fraction, and an aqueous fraction. Heating the wet crude oil in the catalytic heater unit 110 decreases its viscosity, which enhances the separation process inside the three-way separator 30.

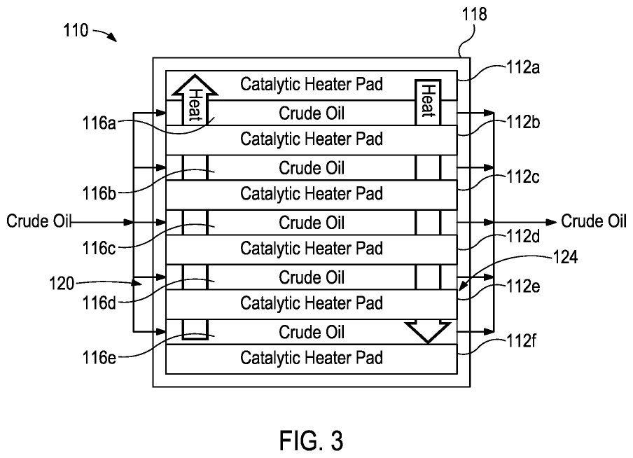

In the illustrated embodiment, the catalytic heater unit 110 includes three oil stream channels 116a-c and four catalytic heating pads 112a-d. In other embodiments, however, the catalytic heater unit 110 may have a greater number of oil stream channels 116a-e, a greater number of catalytic heating pads 112a-f, or both. Referring to FIG. 3, for example, illustrated is a schematic diagram of another example of the catalytic heater unit 110, in accordance with one or more embodiments of the present disclosure. As illustrated, the catalytic heater unit 110 may have a greater number of oil stream channels 116a, 116b, 116c, 116d, 116e and catalytic heating pads 112a, 112b, 112c, 112d, 112e, 112f. Increasing the number of oil stream channels and catalytic heating pads may increase the heating capacity of the catalytic heater unit 110. In an embodiment, the catalytic heater unit 110 has at least three oil stream channels 116a, 116b, 116c. In another embodiment, the catalytic heater unit 110 has at least five oil stream channels 116a, 116b, 116c, 116d, 116e.

Referring again to FIG. 2, in embodiments, gas separated from the wet crude oil in the two-way separator 20 may be used as the hydrocarbon-based fuel in the catalytic heater unit 110. More specifically, as illustrated, a gas supply line 130 may be fluidly coupled to the gas stream 24 discharged from the two-way separator 20 and may convey gas to one or more gas inlets 132, 134 on the catalytic heater unit 110. The flowrate of gas to the catalytic heater unit 110 may be control by a flow control valve 136 arranged within the gas supply line 130. Utilizing gas from the two-way separator 10 may result in cost and energy savings and avoid the extra expenditure that would be required to install extra storage for the natural gas with its associated equipment.

In embodiments, the catalytic heater unit 110 may be thermally and/or electrically insulted. Insulating the catalytic heater unit 110 may prevent heat loss, achieve energy saving, deliver efficient heat duty, prevent gas leaking, and eliminate or decrease the risk of dust or gas explosion. Embodiments of the catalytic heater unit 110 may also be made fire proof and explosion proof, thereby meeting electrical area classification specifications.

In another embodiment, the catalytic heater unit 110 may be used to heat crude oil in other location along the crude oil processing stream. For example, the catalytic heater unit 110 may be used downstream of the three-way separator 30 where the crude oil may be heated further prior to entering a desalter plant to aid in removing the water emulsion.

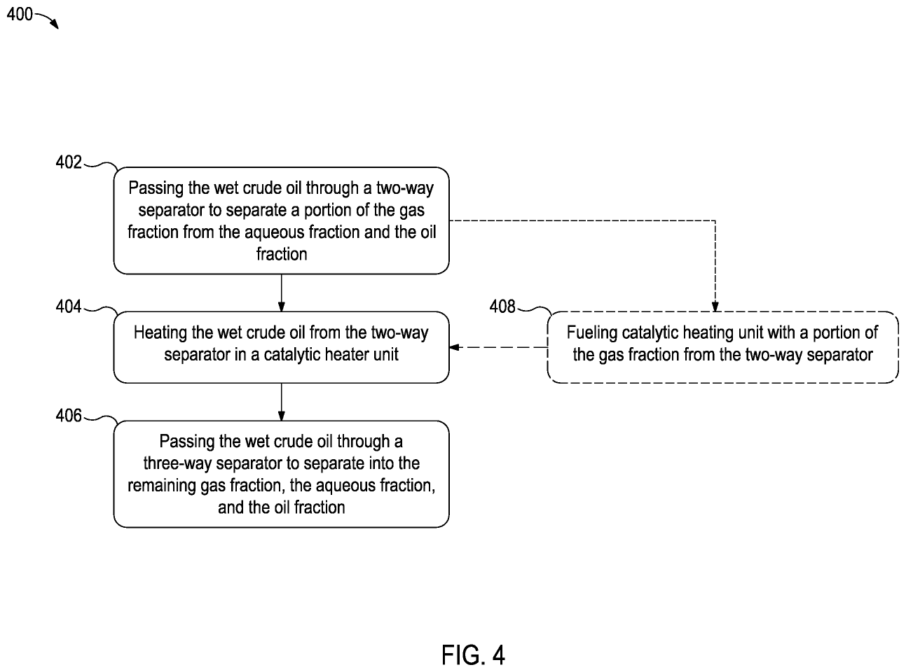

FIG. 4 is a schematic flowchart of an example method 400 of separating a wet crude oil into a gas fraction, an aqueous fraction, and an oil fraction. As illustrated, method 400 may include passing the wet crude oil through a two-way separator to separate a portion of the gas fraction from the aqueous fraction and the oil fraction, as at 402. The method 400 may further include heating the wet crude oil from the two-way separator to a predetermined temperature in a catalytic heater unit, as at 404. The catalytic heater unit may comprises a plurality of catalytic heating pads surrounding at least a portion of a plurality of oil stream channels. The method 400 may further include passing the wet crude oil through a three-way separator to separate into the remaining gas fraction, the aqueous fraction, and the oil fraction, as at 406. The method may optionally include fueling the catalytic heating unit with a portion of the gas fraction separated from the wet crude oil in the 2-way separator, as at 408.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method of separating a wet crude oil into a gas fraction, an aqueous fraction, and an oil fraction, the method comprising:
passing the wet crude oil through a two-way separator to separate a portion of the gas fraction from the aqueous fraction and the oil fraction;
heating the wet crude oil from the two-way separator to a predetermined temperature in a catalytic heater unit, wherein the catalytic heater unit comprises a plurality of catalytic heating pads surrounding at least a portion of a plurality of oil stream channels; and
passing the wet crude oil through a three-way separator to separate into the remaining gas fraction, the aqueous fraction, and the oil fraction.

2. The method of claim 1, further comprising:
flowing a portion of the gas fraction from the two-way separator to the catalytic heating pads;
reacting the portion of the gas fraction with oxygen and thereby producing thermal energy for heating the wet crude oil.

3. The method of claim 1, wherein the predetermined temperature is at least 140° F.

4. The method of claim 1, heating the catalytic heating pad to an activation temperature with an applied electric current, wherein the activation temperature is least 200° F.

5. A system for separating wet crude oil into a gas fraction, an aqueous fraction, and an oil fraction, the system comprising:
a two-way separator operable to separate at least a portion of a gas fraction from the wet crude oil;
a catalytic heater unit arranged to receive the wet crude oil from the two-way separator and operable to heat the wet crude oil to a predetermined temperature and thereby generate a heated wet crude oil; and
a three-way separator arranged to receive the heated wet crude oil from the catalytic heater unit and operable to separate the heated wet crude oil into the gas fraction, the aqueous fraction, and the oil fraction.

6. The system of claim 5, wherein the catalytic heater unit includes a catalytic heating pad that includes at least one catalyst capable of catalyzing a reaction between a hydrocarbon gas and oxygen to produce thermal energy.

7. The system of claim 6, wherein the catalyst is a platinum-based catalyst.

8. The system of claim 5, wherein the catalytic heater unit includes at least three oil stream channels through which the wet crude oil discharged from low-pressure production trap flows.

9. The system of claim 5, wherein the catalytic heater unit includes at least one inlet for receiving a portion of the gas fraction separated from the wet crude oil in the low-pressure production trap.

10. The system of claim 5, wherein the catalytic heating pad includes a substrate coated in a catalyst.

11. The system of claim 10, wherein the substrate is a fiberglass substrate and the catalyst is a platinum based catalyst.

12. The system of claim 10, wherein the substrate coated in the catalyst has a square mesh structure.

13. The system of claim 5, wherein the catalytic heater unit includes at least one oil stream channel through which wet crude oil flows and at least one catalytic heat pad configured to heat the wet crude oil flowing through the at least one oil stream channel.

14. The system of claim 13, further comprising an outer enclosure encompassing the least at least one catalytic heating pad and at least one oil stream channel.

15. The system of claim 14, further comprising at least one inlet for receiving a hydrocarbon-based fuel.
